(19) United States
(12) Patent Application Publication
(10) Pub. No.: US 2007/0045214 A1
(43) Pub. Date: Mar. 1, 2007

(54) Nipple spout

(76) Inventor: James Edward Jennings, Superior, CO (US)

Correspondence Address: JAMES EDWARD JENNINGS, P.O. BOX 270081, LOUISVILLE, CO, 80027, US

(21) Appl. No.: 11/545,009

(22) Filed: Oct. 10, 2006

Related U.S. Application Data
(63) Continuation-in-part of application No. 10/900,216, filed on Jul. 27, 2004.

(51) Int. Cl. A61J 11/00; A61J 9/00

(52) U.S. Cl. 215/11.1

(57) ABSTRACT

The innovation of a five hole isosceles quadrangle shaped Nipple Spout internally attached to a circumferential disk with air vac. The invention increases the use of an easily handled standard baby bottle. By prolonging the attachment with the nipple bottle and replacing with the spout. The spout reduces the transition stage for the child. Thereby, promoting the Nipple Spout as beneficial in reducing stomach gas and development as toddler stage specific.

### CROSS REFERENCE TO RELATED APPLICATIONS

“This is a continuation of application Ser. No. 10/900,216, Filed Jul. 27, 2004, now abandoned.

### FIELD OF INVENTION

The specialization and improvements of nursing bottles, nipples and toddler cups has drawn the invention of a Nipple Spout with Air Vac hole. The location of an air vacuum hole onto the exterior as support and a means for air/gas extraction. Our invention retains a comfortable soft to the palate latex Versus a conventional hard plastic sipping cup lid.

### BACKGROUND OF THE INVENTION

A sipping device that can convert a standard baby bottle into a sipper. This device comprises a rubber nipple spout insert for a threaded o-ring. The Nipple Spout is simply a one-piece rubber isosceles quadrangle with a flat circumference base and evacuation hole. The device is intended for the transition from a baby bottle to a cup. The Nipple Spout cannot be screwed onto a container, it has no threads. The Nipple Spout inserts a standard baby bottle o-ring cap closure.

### OBJECTS AND ADVANTAGES

The chemical inertness of the silicone, its non-allergenic properties and transparency (as well as its ability to stand up to a mauling in the hands of a toddler or infant) make it the ideal material for all baby care product applications. Certain LSR grades comply with FDA food regulation 21 CFR 177.2600 and Bg VV (formerly BGA) XV when correctly processed. Injection Molding of Liquid Silicone Rubber is typically used for manufacturing these items because of its high productivity compared to other materials, a result of the short cycle time during manufacturing. The fully automated manufacturing process and the high number of pieces per manufacturing cycle also benefit the bottom line. A typical curing process takes place at 200*C over a period of 4 hours in an oven with fresh air supply. This allows children to use the optimal Nipple Spout in varied conditions.

Front view illustrates a wide spout to distribute the liquid across the gums onto the tongue and palate. Contamination—These materials are packaged in a closed system; there is less chance of contamination because an operator does not physically touch the material.

Top view illustration displays a three-hole aqueduct system on the apex to channel the flow of liquid. The first three openings are pinholes. The fourth opening is largely within the spout. The fifth hole is located on the lying circular surface sufficient as air vac hole improves fluid passage. Part Configuration—Because of liquid silicone rubber's flow properties, they are ideal for small intricate parts where maintaining tight tolerances is important

### SUMMARY OF INVENTION

This invention provides a liquid Nipple Spout capable of supplying a liquid contained therein, a liquid baby bottle, a securing apparatus, and a method of manufacturing the liquid dispenser.

The Nipple Spout has a flat base and an upwardly extending spout body. The body is sufficiently long enough that by inserting the palatable end. The tip projects for a distance horizontally from the side of the ring cap. The Nipple Spout includes a Isosceles quadrangle portion having a opening there through adequate for uninterrupted fluid. This portion is integrally connected with the base and defines quadrangle circum center reserve for entrance of the liquid into the Nipple Spout. The drinking liquid is dispensed through a three hole rectangular ridge apex there through into a toddler's mouth orifice.

### DETAILED DESCRIPTION OF THE INVENTION

FIG. 1A-C A liquid dispenser includes a base with an air vac hole, and a removable o-ring cover removably secured to the bottle, not to cover the vent. The Nipple Spout has five evacuation holes. The Nipple Spout further includes a one-way disposed air vac hole, the quadrangle circum center reservoir evacuation hole and three hole apex. With the Nipple Spout secured to the lid and bottle, the one-way inhibits air flow into the container through the vent hole while allowing air flow out of the container via the vent hole. With the Nipple Spout removed, the one-way allows bidirectional air flow through the vent hole. An outer surface of the o-ring cap defines a smooth sealing area extending about the evacuation hole for sealing against a latex Nipple Spout and vacuum, held against the bottle's rim over the evacuation hole to dispense the liquid there though the internal rectangle reserve and the apex openings.

The current invention involves a circular base plate with a vacuum generating system. The base plate includes a body having a first external bore beginning near a front edge of the body and extending vertically there through, and a channel formed in the lower surface of the body extending upwardly to the apex of the isosceles quadrangle Nipple Spout. The base plate further includes having a upper edge and lower edge, where Nipple Spout body is integrally formed with the base. The Nipple Spout has a internal bore beginning at the lower edge and extending vertically through the body where the reservoir channel couples the three external rectangle ridge vertex bores. The vacuum system includes a source of air confined within the concave container, and a vent having an outlet port.

The cap may be of molded plastic or an approved material. The cap includes a top wall having a Nipple Spout receivable throughway and vertical walls internally threaded for corresponding bottle rim external screw threads.

In one preferred embodiment of this invention, a one-way valve used is constructed of a flexible rubber sheet. In an area of the flexible sheet, an vac hole portion is formed whose form is maintained in an operation range of the one-way valve.

A system for dispensing liquid from baby bottle containers is disclosed herein. The liquid dispensing system includes a positioned Nipple Spout and ring cap in liquid-flow communication with the bottle container, for transferring liquid from the bottle. A internal positioned evacuation reserve in liquid-flow is disposed to transfer liquid from the bottle container to the apex. When placed in a dispense state a one way valve prevents liquid from flowing through the air valve and allows liquid to flow through the three apex holes. In a upright resting state the valve prevents liquid from flowing through the one way air valve while allowing air to flow through the apex holes. A liquid storage reservoir connected in liquid-flow extraction communication stores liquid received from the bottle. A Nipple Spout non presence of liquid therein, captures its natural form when liquid becomes absent. An one way air valve is disposed to remove air from the liquid baby bottle container above the level of liquid therein.

### BRIEF DESCRIPTION OF SEVERAL VIEWS OF THE DRAWING

FIG. 1A SIDE VIEW OF BASE, QUADRANGLE RESERVOIR, TRIANGLE TO APEX

FIG. 1B FRONT VIEW—ILLUSTRATES APEX WIDTH AND BASE AIR VAC HOLE

FIG. 1C TOP VIEW—ILLUSTRATES EXTERNAL HOLE CONFIGURATION AND CAP

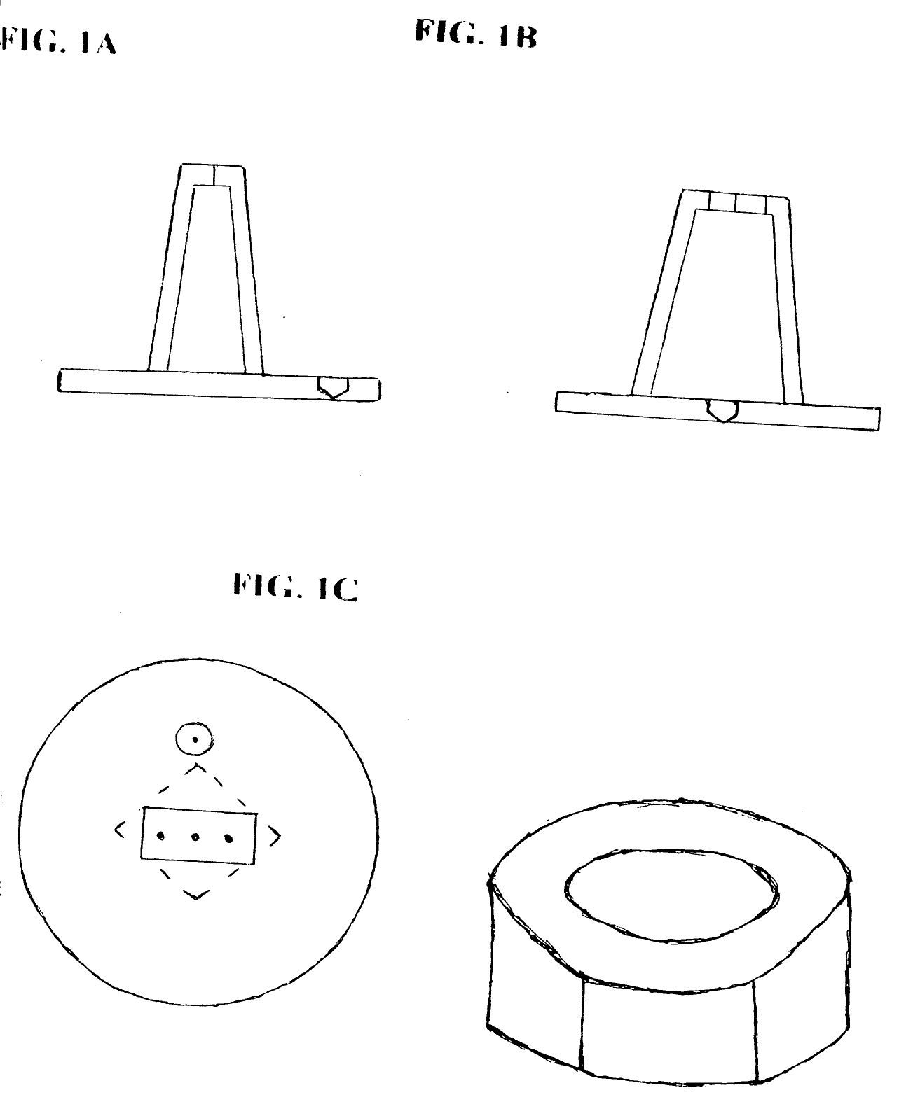

I claim:

1. A Nipple Spout comprising: a vertex altitude three hole apex; and internal relatively large rectangle circum center reservoir hole opening therein, a horizontal circumference disk base with air vac hole, said fourth opening having a hollow chamber, said fifth air vac hole opening spaced apart near front edge, wherein said nipple spout having a lower edge smaller than said circumference base, said Nipple Spout raising upwardly and ascending an isosceles quadrangle, Whereby, bottle liquid flows from a internal rectangle reserve there through said apex ridge three hole openings.

2. A Nipple Spout fluid dispensing component comprising: isosceles quadrangle with an hollow body quadrangle reservoir member communicating and projecting altitude from said body to form an apex ridge, said apex descending downwardly beyond disposed internal quadrangle circum center cavity to a lower circular base, said base front upper edge plane has an air vac hole to evacuate, whereby said Nipple Spout's reservoir and three hole apex ridge fluid contents may be with drawn into the mouth.

3. A method for a baby bottle Nipple Spout device comprising: providing a cap for removably attaching an open upper end and closed bottom container with liquid therein, providing said cap enclosing the said nipple spout with air vac hole, providing also a four hole internal and external aqueduct channel system, providing said nipple spout vertex protruding altitude there through the o-ring cap evacuation, providing said nipple spout lower edge circumferential flat plane base sufficiently at length to capture a seal between the cap's upright internally threaded walls and the flat plane top evacuation surface and the said baby bottle's externally threaded mates rim edge, providing said nipple spout molded from a flexible latex material into an isosceles quadrangle shape with circular disk upper edge having sealable contact with the bored cap, providing said cap spaced laterally therein to avoid coverage of said air vac hole, whereby providing said device secured through communication with aqueduct quadrangle center reservoir having a three hole rectangle apex ridge drinking openings for a toddler to extract liquid.
